(19) United States
(12) Patent Application Publication
(10) Pub. No.: US 2012/0316022 A1
(43) Pub. Date: Dec. 13, 2012

(54) TRANSMISSION SYSTEM FOR A VEHICLE

(76) Inventors: Roell Marie Van Druten, Eindhoven (NL); Alexander Franciscus Anita Serrarens, Waalre (NL); Bas Gerard Vroemen, Eindhoven (NL)

(21) Appl. No.: 13/590,562

(22) Filed: Aug. 21, 2012

Related U.S. Application Data
(63) Continuation of application No. PCT/NL2011/050135, filed on Feb. 24, 2011.

(30) Foreign Application Priority Data
Feb. 24, 2010 (NL) 2004296

(51) Int. Cl. F16H 37/06; F16H 3/72; F16H 9/04

(52) U.S. Cl. 475/5; 74/661; 474/148

(57) ABSTRACT

A transmission system comprises two transmission modules which are arranged in series, an output shaft of the first transmission module being connected via a mount point to an input shaft of the second transmission module. The transmission system further includes an electromotor which is connected to the mount point. The first transmission module is formed by a two-step reduction mechanism and comprises a planetary gear set with at least three rotational members one of which is connected to a brake. The first transmission module further includes a short-circuit clutch which is positioned between the other two rotational members. The brake may be used for launching the vehicle.

### CROSS-REFERENCE TO RELATED APPLICATIONS

This application for a utility patent is a continuation of a previously filed utility patent, now abandoned, having the application number PCT/NL2011/050135, filed Feb. 24, 2011 (Publication No.: W02011/105905).

### DESCRIPTION

1. Field of the Invention

The invention relates to a transmission system for a vehicle comprising a first and a second transmission module which each comprise at least one speed transforming gear and at least one coupling and/or a continuously variable transmission with a controllable variable speed transforming gear, where an input shaft of the first transmission module can be coupled to an end drive which is connected to wheels of the vehicle, which transmission system further includes an electromotor which is coupled to one or both transmission modules.

2. State of the Art

A transmission system of this type is generally known. In the known transmission system the transmission modules are arranged in parallel with each other between the input and the output of the transmission system.

### SUMMARY OF THE INVENTION

It is an object of the invention to provide a transmission system of the type defined in the opening paragraph where the first transmission module can be made as a lighter and more compact version than in the known system. For this purpose the transmission system according to the invention is characterised in that both transmission modules are arranged in series, an output shaft of the first transmission module being connected to an input shaft of the second transmission module, and the electromotor being coupled, via a mount point, to the output shaft of the first transmission module and/or the input shaft of the second transmission module. An advantage of combining the first and second transmission modules is that the transmission range of the first transmission module is allowed to be considerably smaller because the overall transmission range is increased by the second transmission module. This requires fewer gears in the first transmission module, so that it can be designed as a lighter and more compact version.

An embodiment of the transmission system according to the invention is characterised in that the first and/or the second transmission module comprises a continuously variable transmission by means of which various forward gears can be realised between two extreme transmission ratios. An advantage of combining the first and second transmission modules is that the control range of the continuously variable transmission can be reduced, so that the first transmission module may have a better efficiency and be a lighter and more compact version.

The continuously variable transmission preferably comprises two sets of pulleys with an endless flexible transmission element being located in between these pulleys. The transmission element is, for example, a chain or a push and/or pull belt.

A further embodiment of the transmission system according to the invention is characterised in that the first and/or the second transmission module comprises two switchable speed transforming gears by means of which various forward gears can be realized. The two switchable speed transforming gears are preferably formed by two gear trains which can be selected by means of clutches.

An advantageous transmission system is obtained by combining a continuously variable transmission and an automated manual two-gear transmission. This is a highly cost-effective and comfortable automated version. If, when using this transmission system in a vehicle, the changing between the two speed transforming gears occurs when the accelerator pedal is released, this changing gears will take place unnoticed.

A still further embodiment of the transmission system according to the invention is characterised in that the first and/or second transmission module comprises a planetary gear set comprising at least three rotational members, one of which being connected to a brake and the other two being connected to the input and output shaft respectively of the transmission module, and in that, furthermore, there is a short-circuit coupling present between these two rotational members which can connect the two rotational members to each other. When this transmission system is used in a vehicle, the brake can be used for launching the vehicle. If, in addition, a transmission module of this transmission system comprises a continuously variable transmission, the clutch can be used to form a regime switch, so that the range of the continuously variable transmission may be passed through twice. This regime switch can be realized without torque interruption by proper power assistance of clutch and brake.

Yet a further embodiment of the transmission system according to the invention is characterised in that the transmission system comprises a further coupling which can directly couple the input shaft of the first transmission module to the output shaft of the second transmission module. By connecting the input shaft of the first transmission module to the output shaft of the second transmission module, a direct drive (prise direct) may be created.

Preferably, a reverse gear is present in the first or second transmission module. If one transmission module is arranged as a continuously variable transmission and the other one by two gear trains which may be selected by means of a clutch, it is preferred to accommodate the reverse gear in the latter transmission module.

Furthermore, preferably a clutch is present between the electromotor and the mount point, so that the electromotor can be disengaged if it is not in operation and thus need not rotate in unison unnecessarily.

A still further embodiment of the transmission system according to the invention is characterised in that the transmission system comprises a first end drive whose input shaft is connected to the output shaft of the second transmission module and whose output shaft can be coupled to the driven wheels of the vehicle, as well as a second end drive which comprises an input shaft which can be coupled to the electromotor and/or to the mount point.

The invention likewise relates to a vehicle comprising a drive source, an end drive, driven wheels which are connected to the end drive, and a drive line through which the end drive is connected to the drive source. As regards the vehicle, the invention is characterised in that the drive line comprises a transmission system according to the invention, where the input shaft of the first transmission module is connected to the drive source and the output shaft of the second transmission module is connected to the end drive and where the end drive is only connected to the rear wheels of the vehicle.

### BRIEF DESCRIPTION OF THE DRAWINGS

The invention will be described below in more detail based on examples of embodiment of the transmission system according to the invention represented in the drawing figures, in which:

FIG. 1 gives a diagrammatic representation of a first embodiment of the transmission system according to the invention;

FIG. 2 gives a diagrammatic representation of a second embodiment of the transmission system according to the invention;

FIG. 3 gives a diagrammatic representation of a third embodiment of the transmission system according to the invention;

FIG. 4 shows a constructive lay out of the transmission system represented in FIG. 3;

FIG. 5 gives a diagrammatic representation of a fourth embodiment of the transmission system according to the invention;

FIG. 6 shows a constructive lay out of the transmission system represented in FIG. 5;

FIG. 7 shows another constructive lay out of the transmission system represented in FIG. 5;

FIG. 8 gives a diagrammatic representation of the lay out represented in FIG. 7;

FIG. 9 shows a lay out of a fifth embodiment of the transmission system according to the invention;

FIG. 10 gives a diagrammatic representation of the lay out shown in FIG. 9;

FIG. 11 shows a lay out of a sixth embodiment of the transmission system according to the invention; and

FIG. 12 shows a variant of the lay out shown in FIG. 11.

### DETAILED DESCRIPTION OF THE DRAWINGS

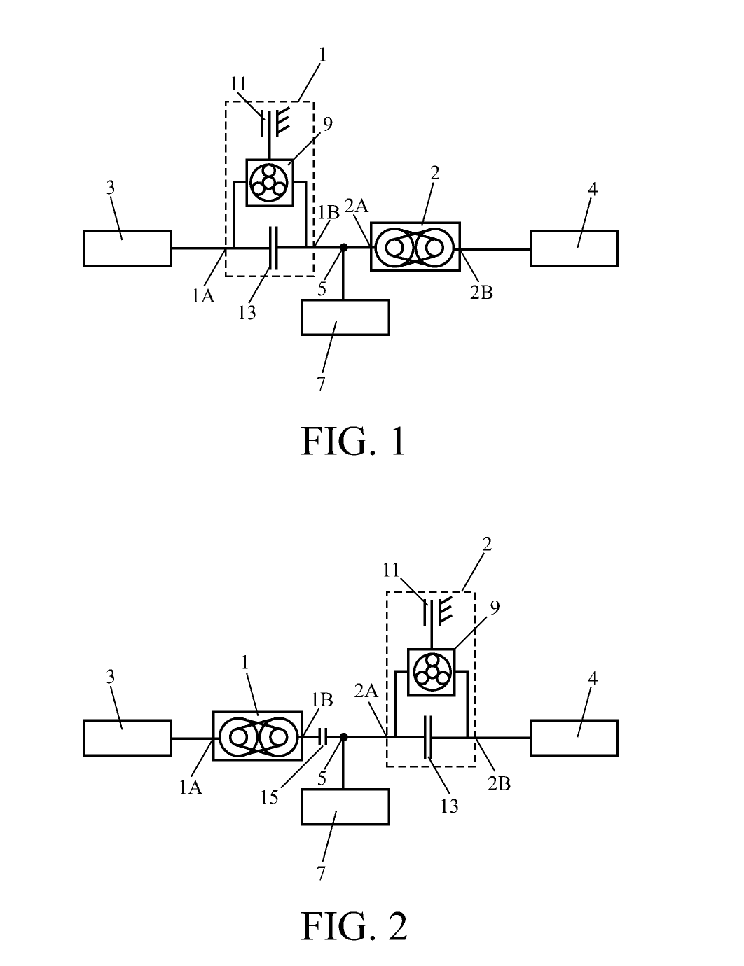

FIG. 1 gives a diagrammatic representation of a first embodiment of the transmission system according to the invention, used in a vehicle. The transmission system comprises two transmission modules 1 and 2 connected in series to each other while an input shaft 1A of the first transmission module 1 is coupled to a drive source 3 and an output shaft 2B of the second transmission module 2 is coupled to a load 4 which is formed by an end drive and vehicle wheels connected thereto. The output shaft 1B of the first transmission module 1 is connected, via a mount point 5, to an input shaft 2A of the second transmission module 2. The transmission system further includes an electromotor 7 which is connected, via the mount point 5, to the output shaft 1B of the first transmission module 1 and the input shaft 2A of the second transmission module 2.

The first transmission module 1 is formed by a two-step gear reduction mechanism and has a planetary gear set 9 comprising at least three rotational members one of which is connected to a brake 11 and the other two are connected to the input shaft 1A and the output shaft 1B respectively of the transmission module. The first transmission module 1 further includes a short-circuit clutch 13 which is positioned between these two rotational members and which can connect these rotational members to each other. The brake 11 may be used for launching the vehicle. The second transmission module 2 is formed by a continuously variable transmission. The short-circuit clutch 13 may be used to form a regime switch so that the range of the continuously variable transmission can be gone through twice. This regime switch can be effected without a torque interruption by proper assistance of the short-circuit clutch 13 and the brake 11.

FIG. 2 represents a second embodiment of the transmission system according to the invention, used in a vehicle. Compared to the first embodiment described hereinbefore, the first transmission module 1 is arranged here as a continuously variable transmission and the second transmission module 2 as a two-step reduction with a planetary gear set. A clutch 15 is positioned between the electromotor 7 and the continuously variable transmission. As a result, the vehicle can be driven purely electrically without the continuously variable transmission working in unison.

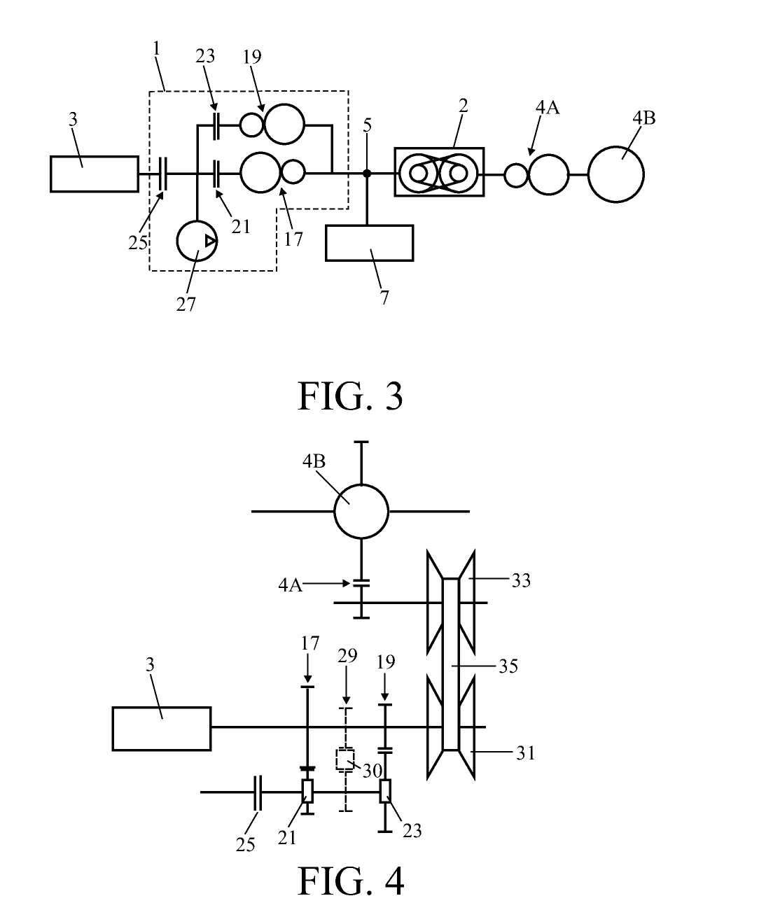

FIG. 3 represents a third embodiment of the transmission system according to the invention, used in a vehicle. The load is indicated here as an end drive 4A and a differential 4B connected to it. The first transmission module 1 is formed by a two-step gear reduction mechanism comprising two gear sets 17 and 19 which can be selected by two clutches 21 and 23. Furthermore, there is a main clutch 25 connected to the input shaft 1A and an optional oil pump 27 for regulating the continuously variable transmission. This main clutch 25 is arranged as a dry plate clutch which is operated automatically. The first transmission module 1 is arranged as an automated manual transmission having two gears. Optionally the first transmission may also include a reverse transmission 29, see FIG. 4 in which a constructive lay out of the transmission system shown in FIG. 3 is represented. The centre gear wheel 30 of the reverse transmission 29 is displaceable here and, when driving forward, may be brought out of engagement with the other two gear wheels of this reverse transmission. The continuously variable transmission includes two pulley sets 31 and 33 between which is positioned an endless flexible transmission element 35. This transmission element is, for example, a chain or a push belt.

The combination of a continuously variable transmission (transmission module 2) and an automated manual transmission with two gears (transmission module 1) provides a highly cost effective and comfortable automatic gear box. The gear change may be effected with an interruption of torque transfer by first opening the main clutch 25 and then operating the clutches 21 and 23, after which the main clutch 25 can be closed again. This gear change preferably takes place when the accelerator pedal is let go of by the driver, so that the clutch action takes place unnoticed.

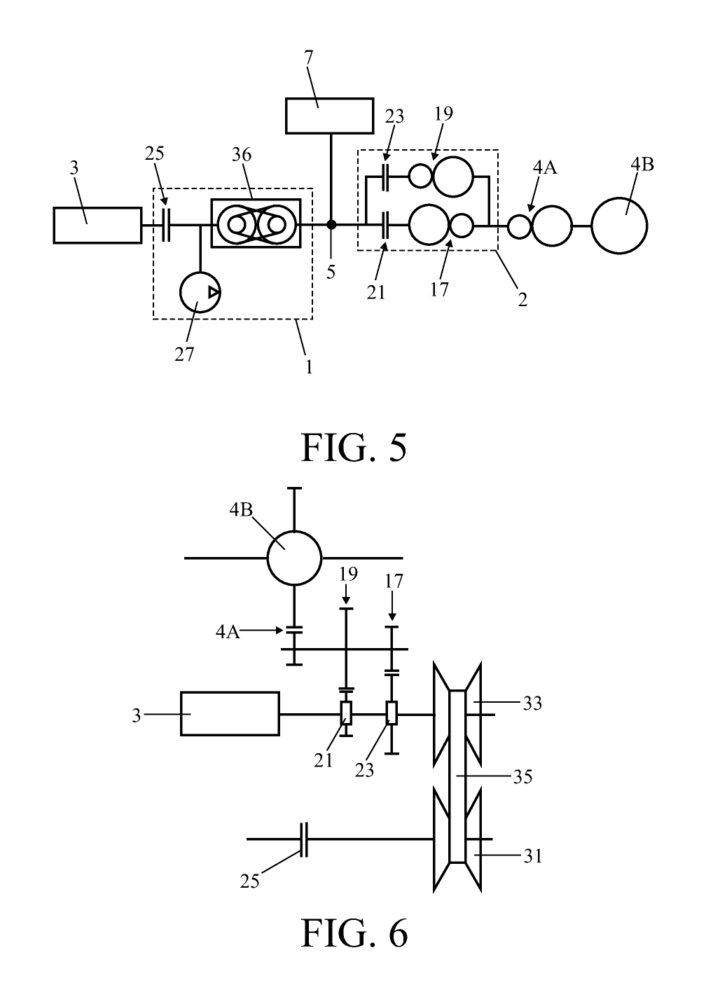

FIG. 5 represents a fourth embodiment of the transmission system according to the invention used in a vehicle. Compared to the third embodiment described hereinbefore the first transmission module 1 here includes a continuously variable transmission 36 and the second transmission module 2 is arranged as a two-step transmission comprising two gear sets 17 and 19 which may be selected by the clutches 21 and 23.

An advantage of the secondary placed two-step transmission is that the incoming torque and revolutions per minute of the continuously variable transmission 36 do not rise. An additional advantage is that the maximum output revolutions per minute drops as a result of which the centrifugal load of the belt (or chain) drops and the loadability (max. torque) rises.

For starting the motor, the clutches 21 and 23 need to be open if the main clutch 25 is closed in non-operated state. A possible mechanically driven oil pump is preferably connected between the main clutch 25 and clutch 21 or 23.

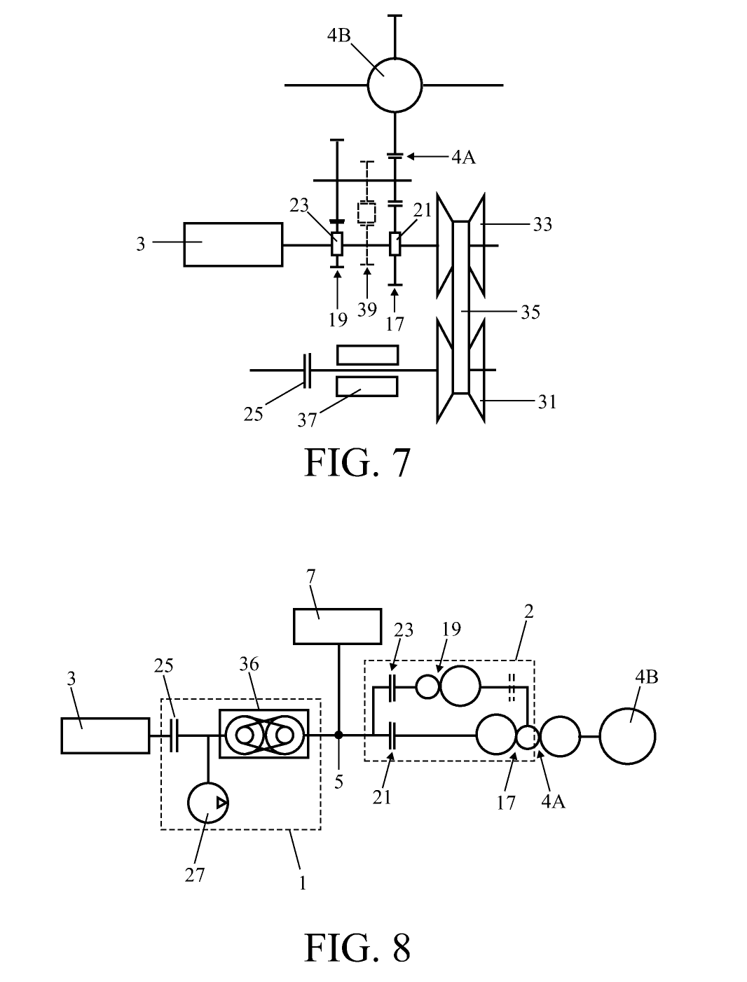

For illustrative purposes FIG. 6 shows a constructive lay out of the transmission system represented in FIG. 5 and FIG. 7 shows another constructive lay out of the transmission system represented in FIG. 5. The latter embodiment is more compact in axial direction than the embodiment shown in FIG. 6 because the actuator 37 of the main clutch 25 may be arranged in parallel with the second transmission module. Furthermore, a gear wheel of the second transmission module is combined with the end drive so that one gear wheel is saved on. In addition, in this second transmission module may be present a reverse transmission 39, which is indicated by broken lines. For illustrative purposes FIG. 8 gives a diagrammatic representation of the lay out represented in FIG. 7. The clutch 23 may also be placed to the right of the gear set 19 if so desired, which is indicated by broken lines too.

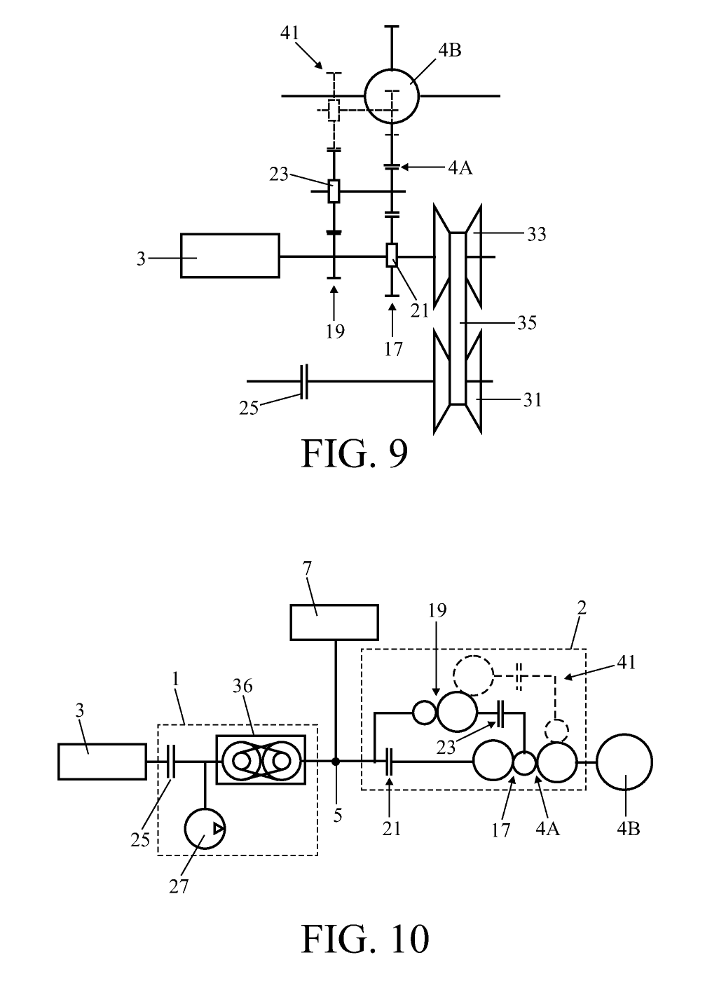

FIG. 9 shows a lay out of a fifth embodiment of the transmission system according to the invention. The difference compared with the transmission system shown in FIG. 7 is that the reverse transmission 41 is arranged in an alternative manner. As a result, another gear wheel more is saved on. For illustrative purposes FIG. 10 gives a diagrammatic representation of the lay out shown in FIG. 9.

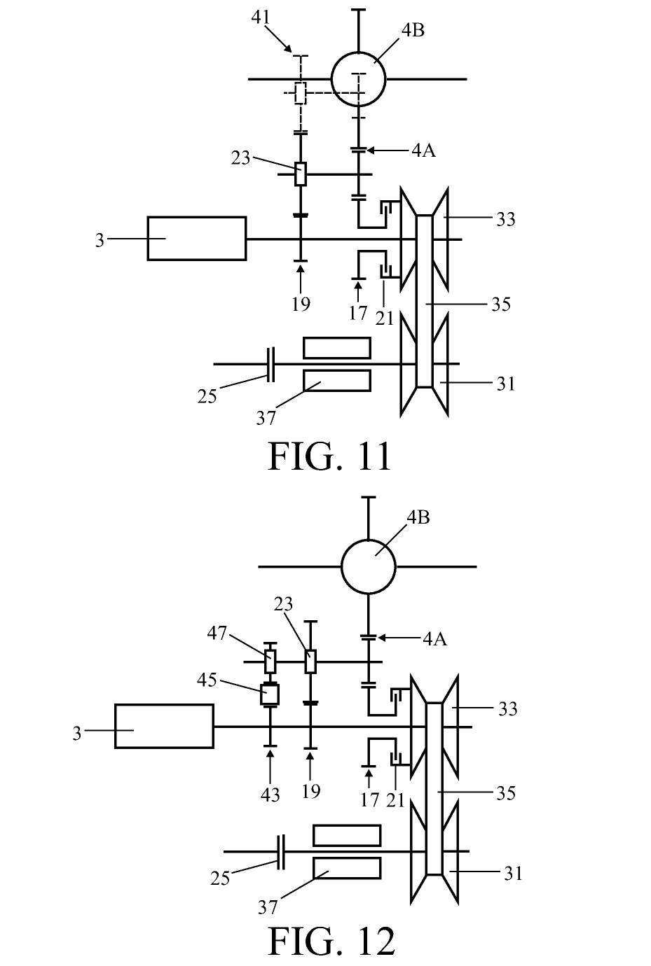

If the clutch 21 is arranged as a friction clutch, see FIG. 11, changing gear between the two forward transmissions may be effected without torque interruption. The clutch 21 is then preferably arranged as a wet plate clutch.

The requirements which the gear wheels forming the reverse transmission 43 are to satisfy are low in all variants described hereinbefore, because they are loaded only when the vehicle is reversed. These gear wheels, however, are to run silently because they always run in unison when unloaded. This would not be necessary if the intermediate gear wheel 45 were installed slidable, as is shown in the variant shown in FIG. 12. By having the reverse transmission 43 to include the intermediate gear wheel 45, the transmission module is somewhat broader it is true, but the advantage of this is that the operation of the clutches 23 and 47 can be combined because they are now present on the same shaft.

Albeit the invention has been described in the foregoing based on the drawings, it should be observed that the invention is not by any manner or means restricted to the embodiment shown in the drawings. The invention also extends to all embodiments deviating from the embodiment shown in the drawings within the spirit and scope defined by the claims.

1. A transmission system for a vehicle, the transmission system comprising:
a first and a second transmission module which each comprise at least one speed transforming gear and at least one coupling and/or a continuously variable transmission with a controllable variable speed transforming gear, where an input shaft of the first transmission module can be coupled to a drive source and an output shaft of the second transmission modulecan be coupled to an end drive which is connected to wheels of the vehicle, which transmission system further includes an electromotor which is coupled to one or both transmission modules, wherein both transmission modules are arranged in series, an output shaft of the first transmission module being connected to an input shaft of the second transmission module, and the electromotor being connected, via a mount point, to the output shaft of the first transmission module and/or the input shaft of the second transmission module.

2. A transmission system as claimed in claim 1, wherein the first and/or the second transmission module comprises a continuously variable transmission by means of which various forward gears can be realized between two extreme transmission ratios.

3. A transmission system as claimed in claim 2, wherein the continuously variable transmission comprises two sets of pulleys with an endless flexible transmission element being located in between these pulleys.

4. A transmission system as claimed in claim 1, wherein the first and/or the second transmission module comprises two switchable speed transforming gears by means of which various forward gears can be realized.

5. A transmission system as claimed in claim 4, wherein the two switchable speed transforming gears are formed by two gear trains which can be selected by means of clutches.

6. A transmission system as claimed in claim 4, wherein the two switchable speed transforming gears are formed by a planetary gear set comprising at least three rotational members, one of which being connected to a brake and the other two being connected to the input and output shaft respectively of the transmission module, and in that, furthermore, there is a short-circuit coupling present between these two rotational members which can connect the two rotational members to each other.

7. A transmission system as claimed in claim 1, wherein the transmission system comprises a further coupling which can directly couple the input shaft of the first transmission module to the output shaft of the second transmission module.

8. A transmission system as claimed in claim 1, further comprising a reverse gear in the first or second transmission module.

9. A transmission system as claimed in claim 1, further comprising a clutch between the electromotor and the mount point.

10. A transmission system as claimed in claim 1, wherein the transmission system comprises a first end drive whose input shaft is connected to the output shaft of the second transmission module and whose output shaft can be coupled to the driven wheels of the vehicle, as well as a second end drive which comprises an input shaft which can be coupled to the electromotor and/or to the mount point.

11. A vehicle comprising:
a drive source;
an end drive;
driven wheels which are connected to the end drive; and
a drive line through which the end drive is connected to the drive source, wherein the drive line comprises a transmission system comprising:
a first and a second transmission module which each comprise at least one speed transforming gear and at least one coupling and/or a continuously variable transmission with a controllable variable speed transforming gear, where an input shaft of the first transmission module can be coupled to a drive source and an output shaft of the second transmission modulecan be coupled to an end drive which is connected to wheels of the vehicle, which transmission system further includes an electromotor which is coupled to one or both transmission modules, wherein both transmission modules are arranged in series, an output shaft of the first transmission module being connected to an input shaft of the second transmission module, and the electromotor being connected, via a mount point, to the output shaft of the first transmission module and/or the input shaft of the second transmission module;
wherein the input shaft of the first transmission module is connected to the drive source and the output shaft of the second transmission module is connected to the end drive and where the end drive is only connected to the rear wheels of the vehicle.
